(19) United States
(12) Patent Application Publication
(10) Pub. No.: US 2012/0299799 A1
(43) Pub. Date: Nov. 29, 2012

(54) Antenna With Feed Cable Support Member

(75) Inventors: Tsung-Wen Chiu, New Taipei City (TW); Fu-Ren Hsiao, New Taipei City (TW)

(73) Assignee: ADVANCED CONNECTEK, INC., New Taipei City (TW)

(21) Appl. No.: 13/204,066

(22) Filed: Aug. 5, 2011

(30) Foreign Application Priority Data
May 27, 2011 (TW) 100118618

(51) Int. Cl. H01Q 1/00

(52) U.S. Cl. 343/905

(57) ABSTRACT

An antenna with a feed cable support member comprises a first conductor, a pivotal shaft, a second conductor and a feed cable. The first and second conductors respectively connect with two sides of the pivotal shaft. The pivotal shaft enables the first and second conductors to open or close by 0-180 degrees. The support member is connected with one end of the pivotal shaft and disposed inside the slot between the first and second conductors. The feed cable has a high frequency signal feeding terminal fixed to the surface of the support member. Based on the principle of an aperture coupled antenna, the present invention adds the support member into the slot, whereby the high frequency signal feeding terminal can be directly fixed to the surface of the support member, and whereby the operating frequency and impedance matching can be fine tuned via the support member.

### BACKGROUND OF THE INVENTION

1. Field of the Invention

The present invention relates to an antenna with a feed cable support member, particularly to an antenna based on the principle of the aperture coupled antenna, wherein a support member is disposed in the slot between conductors to adjust the operating frequency bands and impedance matching.

2. Description of the Related Art

After notebook computers have stepped into the mobile communication industry, the manufacturers not only have to add standard 3 G communication modules to notebook computers but also have to propose superior antenna designs and construction tactics for RF systems, so as to precisely and noiselessly transceive signals in the environment full of interference sources. A notebook computer needs several sets of antennae and requires a slim and exquisite appearance. How to optimize the performance of co-existing antennae and meet the requirement of appearance is also a problem. A notebook computer may have upper and lower casings made of metal. For esthetics, graphite fiber must be integrated with the metallic plates. In such a case, the antennae are more likely to have interference, and the space for antenna layout is further restricted. How to integrate several antenna modules into a limited space and avoid mutual interference has been a big challenge for designers.

In the conventional technology, the metallic plate is cut to have a notch functioning as the so-called RF window in the notebook computer having metallic upper and lower casings. The RF window is normally disposed above the monitor of the notebook computer. However, such a design causes the casing of the notebook computer to have fractal slits and affects the appetite to buy it. Besides, the feed cables are extended along the laterals of the upper and lower casings and the pivotal shaft. Such an approach causes too long a transmission path and too great a radiation loss and thus degrades the overall radiation efficiency.

### SUMMARY OF THE INVENTION

One objective of the present invention is to provide an antenna with a feed cable support member, which is designed according to the principle of the aperture coupled antenna, wherein a support member is arranged in a slot between a first conductor and a second conductor, and wherein high-frequency signals are fed to the support member to realize an aperture coupled antenna, and wherein the length and thickness of the support member is controlled to fine tune the operating frequency and impedance matching of the antenna system, whereby the antenna has superior impedance bandwidth.

Another objective of the present invention is to provide an antenna with a feed cable support member, wherein a support member is arranged between a first conductor and a second conductor, and wherein the high frequency signal feeding terminal of the feed cable is directly fixed to the surface of the support member, whereby is overcome the conventional problem that the feed cable wound around the pivotal shaft is likely to bend and break when the user repeats opening and closing the first and second conductors via the pivotal shaft.

A further objective of the present invention is to provide an antenna with a feed cable support member, which is exempted from cutting an RF window in the lateral of the metallic plate but adds a support member to between a first conductor and a second conductor, whereby are greatly shortened the wiring length of the feed cable and the transmission path of signals, and whereby are decreased the loss of radiation signals and interference among antennae.

To achieve the abovementioned objectives, the present invention proposes an antenna with a feed cable support member, which comprises a first conductor, a pivotal shaft, a second conductor, a support member and a feed cable. Two sides of the pivotal shaft are respectively connected with first conductor and the second conductor, whereby a 0-180 degree opening or closing activity of the first and second conductors can be realized via the pivotal shaft. The support member is connected with one end of the pivotal shaft and arranged in the slot between the first and second conductors. The feed cable has a high frequency signal feeding terminal and is fixed to the surface of the support member.

The present invention involves an improved design of the high frequency feed cable of an antenna, wherein a support member is arranged between a first conductor and a second conductor, and wherein the high frequency signal feeding terminal of the feed cable is directly fixed to the surface of the support member. The present invention is exempted from winding the feed cable around the pivotal shaft. Therefore, the present invention can prevent the feed cable from bending and breaking when the user opens and closes the first and second conductors repeatedly. Thus are reduced the interference of noise and the probability of electric disconnection.

The present invention is based on the principle of the aperture coupled antenna. In the present invention, a support member extends inside a narrow and long slot between a first conductor and a second conductor, and high frequency signals are fed to the first or second conductors via the support member. Thereby is formed the structure of an aperture coupled antenna. The impedance matching and operating frequency of the antenna system are fine tuned via modifying the length and thickness of the support member to obtain the frequency band required by the antenna system. Thus, the antenna has smoother impedance variation and superior impedance bandwidth.

Below, embodiments are described in detail to make easily understood the technical contents of the present invention.

### BRIEF DESCRIPTION OF THE DRAWINGS

FIG. 1 is a locally enlarged view of an antenna with a feed cable support member according to a first embodiment of the present invention;

FIG. 2 is a perspective view of the application of an antenna with a feed cable support member according to the first embodiment of the present invention;

FIG. 3 is a top view of an antenna with a feed cable support member according to the first embodiment of the present invention;

FIG. 4 is a locally enlarged view of an antenna with a feed cable support member according to a second embodiment of the present invention; and

FIG. 5 is a perspective view of the application of an antenna with a feed cable support member according to the second embodiment of the present invention.

### DETAILED DESCRIPTION OF THE INVENTION

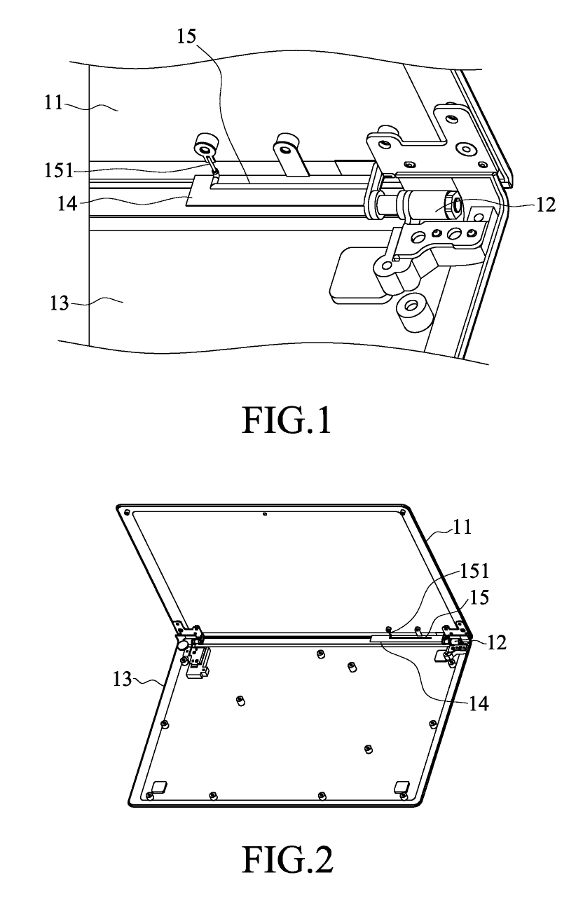

Refer to FIG. 1 a locally enlarged view of an antenna with a feed cable support member according to a first embodiment of the present invention. The antenna with a feed cable support member of the present invention comprises a first conductor 11, a pivotal shaft 12, a second conductor 13, a support member 14 and a feed cable 15. The feed cable 15 has a high frequency signal feeding terminal 151.

In assemblage, the first conductor 11 is connected with one side of the pivotal shaft 12, and the second conductor 13 is connected with another side of the pivotal shaft 12. Via the pivotal shaft 12, the first and second conductors 11 and 13 can be 0-180 degree opened and closed. The first conductor 11, the pivotal shaft 12 and the second conductor 13 are made of electric conduction materials. Thereby, electric signals can be conducted along the path of the first conductor 11, the pivotal shaft 12 and the second conductor 13 or along the path of the second conductor 13, the pivotal shaft 12 and the first conductor 11. Normally, the first and second conductors 11 and 13 are baseplates made of a metal or the casing of a wireless communication device.

The present invention is characterized in that a support member 14 is connected with one side of the pivotal shaft 12 and disposed in the interior of the slot between the first and second conductors 11 and 13 to form a structure similar to an aperture coupled antenna. The high frequency signal feeding terminal 151 of the feed cable 15 is fixedly arranged on the surface of the support member 14. The high frequency signal feeding terminal 151 of the feed cable 15 is connected with either the first conductor 11 or the second conductor 13. Since the first conductor 11, the pivotal shaft 12 and the second conductor 13 are made of electric conduction materials, the electric signals can always be conducted no matter which one of the first conductor 11 or the second conductor 13 is connected with the high frequency signal feeding terminal 151 of the feed cable 15. In the first embodiment, the high frequency signal feeding terminal 151 is connected with the first conductor 11. As the high frequency signal feeding terminal 151 of the feed cable 15 is directly fixed to the surface of the support member 14, the feed cable 15 would not bend or break even though the pivotal shaft 12 undertakes opening and closing activities repeatedly.

Further, the support member 14 extends in the slot between the first and second conductors 11 and 13. The operating frequency and impedance matching of the antenna system can be fine tuned to obtain superior impedance bandwidth via controlling the length and thickness of the support member 14. Thereby is not only increased radiation area but also solved the problem that the feed cable 15 installed on the pivotal shaft 12 is embrittled or fractured.

In one embodiment, the first conductor 11 has a rectangle-like shape with a length of about 400 mm, and width of about 200 mm and a thickness of about 1 mm. The pivotal shaft 12 has a cylinder-like shape with a length of about 40 mm and a diameter of about 25 mm. The second conductor 13 has a rectangle-like shape with a length of 420 mm, a width of about 210 mm and a thickness of about 1 mm. The support member 14 is a rectangular strip having a length of about 100 mm, a width of about 15 mm and a thickness of about 2 mm.

Refer to FIG. 2 a perspective view of the application of an antenna with a feed cable support member according to the first embodiment of the present invention. In the slot between the first and second conductors 11 and 13, the support member 14 extends from one end of the pivotal shaft 12. As the support member 14 is very tiny and only occupies a very small space of the slot, it neither retards opening or closing the first and second conductors 11 and 13 nor impairs assembling the components inside the slot. Further, the operating frequency and impedance matching of the antenna system can be fine tuned to obtain superior impedance bandwidth via fine tuning the length and thickness of the support member 14. Furthermore, the wiring of connecting the high frequency signal feeding terminal 151 with the first conductor 11 would not impair opening or closing the first and second conductors 11 and 13.

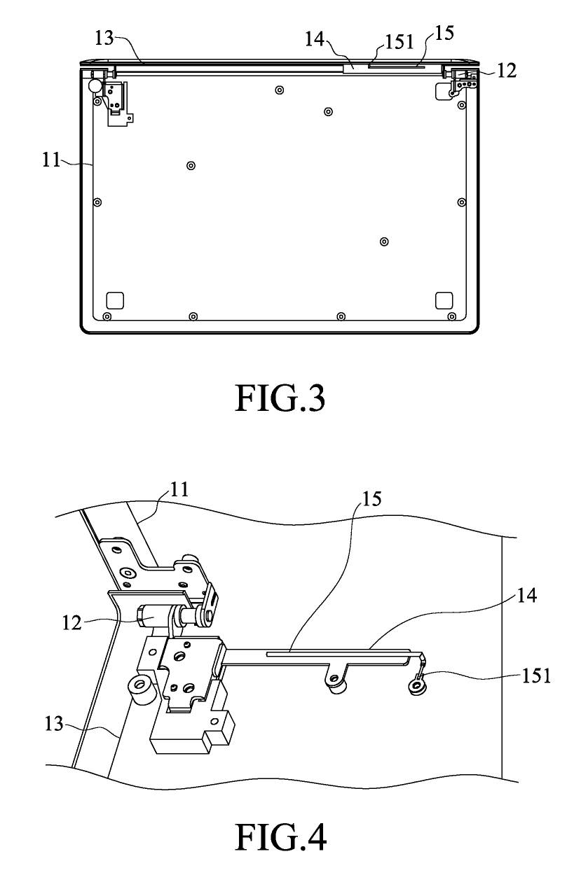

Refer to FIG. 3 a top view of an antenna with a feed cable support member according to the first embodiment of the present invention. The present invention features a rectangular strip-like support member 14 arranged inside the slot between the first and second conductors 11 and 13. The support member 14 is mainly used to accommodate the high frequency signal feeding terminal 151. As the feed cable 15 and the high frequency signal feeding terminal 151 thereof are very thin, the support member 14 does not need too large an area. Thus, the feed cable 15 and the high frequency signal feeding terminal 151 thereof can be completely disposed inside the slot between the first and second conductors 11 and 13 without the problem of collecting them.

Refer to FIG. 4 a locally enlarged view of an antenna with a feed cable support member according to a second embodiment of the present invention. The second embodiment is basically similar to the first embodiment but different from the first embodiment in that the high frequency signal feeding terminal 151 of the feed cable 15 is connected with the second conductor 13. Since the first conductor 11, the pivotal shaft 12 and the second conductor 13 are made of electric conduction materials, electric signals can be transmitted to the first conductor 11 via the second conductor 13 and the pivotal shaft 12. Thus, conduction of electric signals is not affected by connecting the high frequency signal feeding terminal 151 with the second conductor 13.

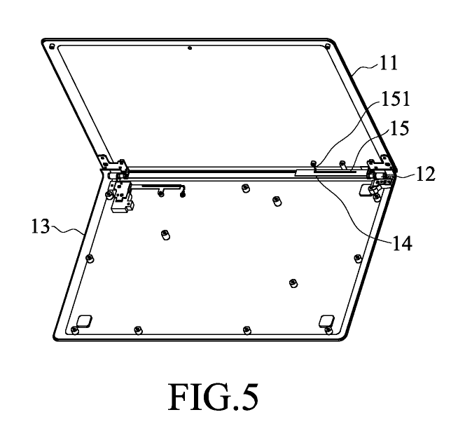

Refer to FIG. 5 a perspective view of the application of an antenna with a feed cable support member according to the second embodiment of the present invention. In the present invention, no matter whether the support member 14 is extended from the end of the left or right pivotal shaft 12, it can always be properly arranged inside the slot between the first and second conductors 11 and 13. In the present invention, the feed cable 15 is neither bent nor wound and thus is exempted from fracture. Thereby, the present invention can decrease the probability of noise interference.

The above description has proved that the present invention possesses utility, novelty and non-obviousness and meets the condition for a patent. Thus, the Inventors file the application for a patent. It will be appreciated if the patent is approved fast.

The embodiments described above are only to exemplify the present invention but not to limit the scope of the present invention. Any equivalent modification or variation made by the persons skilled in the art is to be also included within the scope of the present invention.

What is claimed is:

1. An antenna with a feed cable support member, comprising
a first conductor;
a pivotal shaft with one side thereof connected with said first conductor;
a second conductor connected with another side of said pivotal shaft, wherein said pivotal shaft implements opening or closing of said first conductor and said second conductor;
a support member connected with one end of said pivotal shaft and disposed in a slot between said first conductor and said second conductor; and
a feed cable having a high frequency signal feeding terminal fixed to a surface of said support member.

2. The antenna with a feed cable support member according to claim 1, wherein said pivotal shaft enables said first conductor and said second conductor to open or close by 0-180 degrees.

3. The antenna with a feed cable support member according to claim 1, wherein each of said pivotal shaft, said first conductor and said second conductor is made of an electric conduction material.

4. The antenna with a feed cable support member according to claim 1, wherein each of said first conductor and said second conductor is a baseplate or casing of a wireless communication device.

5. The antenna with a feed cable support member according to claim 1, wherein said high frequency signal feeding terminal of said feed cable is connected with one of said first conductor and said second conductor.
